(19) United States
(12) Patent Application Publication
(10) Pub. No.: US 2004/0079401 A1
(43) Pub. Date: Apr. 29, 2004

(54) Re-useable filter cleaning apparatus

(76) Inventor: Gerald F. Smith, Watertown, MN (US)

Correspondence Address: BRIGGS AND MORGAN, P.A., 2400 IDS CENTER, MINNEAPOLIS, MN, 55402, US

(21) Appl. No.: 10/280,536

(22) Filed: Oct. 24, 2002

(51) Int. Cl. B08B 3/04

(52) U.S. Cl. 134/104.4; 134/109; 134/140; 134/144; 134/152; 134/155; 134/157

(57) ABSTRACT

An apparatus for cleaning re-usable filters, the re-usable filter having an axis, the apparatus. The apparatus includes a source of cleaning fluid; a receptacle for dirty cleaning fluid; a mount for holding the re-usable filter, the mount spinning about the filter's axis; a nozzle for directing a spray of cleaning fluid against the filter; a pump for delivering cleaning fluid from the source of cleaning fluid to the nozzle; and a cover for enclosing the apparatus.

### BACKGROUND OF THE INVENTION

This invention relates to an apparatus for cleaning re-usable filters, and in particular to an apparatus that uses high-pressure water with or without a biodegradable soap to clean dirt and oil from the filter.

Fluid filters are used to remove contaminants from fluid such as engine oil. Internal combustion engines use oil to lubricate bearings and reduce friction. This oil is circulated through the engine and carries contaminants such as metal particles, carbon particles and dirt which may cause harm to the engine. In order to effectively lubricate the engine, engine oil is passed through a filter to remove the contaminants before the oil is re-circulated to the engine. The typical oil filter is attached to an internal combustion engine at the oil filter receptacle. Engine oil passes through a discharge opening in the oil filter receptacle, into a fluid filter and then into the engine lubrication system through an oil inlet pipe. A filter element in the fluid filter removes contaminants from the oil before it re-enters the engine through the oil inlet pipe. Because of the dynamic nature of this process, oil filters must be sealed to protect them from oil leaking into the atmosphere.

Oil filters have traditionally been of a disposable type creating a great environmental concern. Used oil filters are disposed of in landfills or by incinerating. Recent improvements in the art have separated the filter elements from the filter canister allowing users to dispose of only the filter element and thus reducing the quantity of waste material. However, a large volume of waste is still generated by disposing of the filter element.

Other improvements in the art have resulted in re-usable filter elements, typically constructed of wire mesh. While these filter elements can be re-used, they must first be cleaned. Cleaning such filter elements has been a labor-intensive process.

There is a need for an apparatus to clean re-usable filter elements to reduce the time and labor involved. Ideally, the apparatus would use water with or without biodegradable soap, rather than a chemical solvent for cleaning, in order to reduce pollution of the environment.

### SUMMARY OF THE INVENTION

Apparatus for cleaning re-usable filters, the re-usable filter having an axis, the apparatus comprising:

a) a source of cleaning fluid;

b) a receptacle for dirty cleaning fluid;

c) a mount for holding the re-usable filter, the mount spinning about the filter's axis;

d) a nozzle for directing a spray of cleaning fluid obliquely against the filter;

e) a pump for delivering cleaning fluid from the source of cleaning fluid to the nozzle; and

f) a cover for enclosing the apparatus.

A principle object and advantage of the present invention is that it greatly reduces the manual labor involved in cleaning re-usable filter elements.

Another principle object and advantage of the present invention is that it can use water with or without a biodegradable soap, rather than a chemical solvent.

### BRIEF DESCRIPTION OF DRAWINGS

FIG. 1 is a perspective view of the apparatus of the present invention.

FIG. 2 is a detailed perspective view of a portion of the apparatus of the present invention.

FIG. 3 is a top plan view of the spinning filter mount of the apparatus of the present invention.

FIG. 4 is a cross-section of the apparatus of the present invention.

FIG. 5 is a side elevational view of the apparatus of the present invention with some structure broken away to show internal detail.

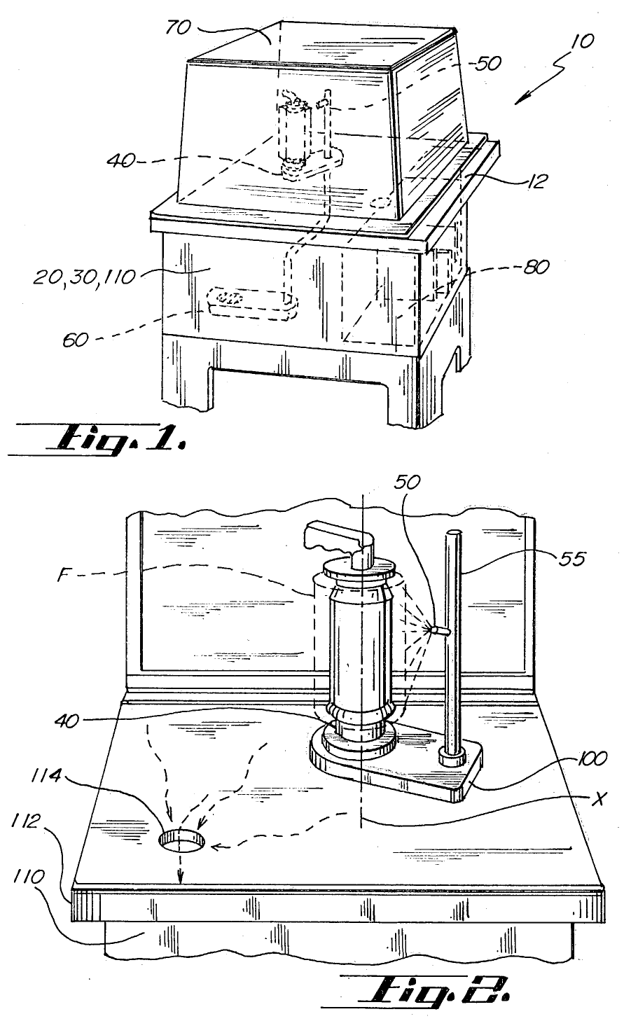

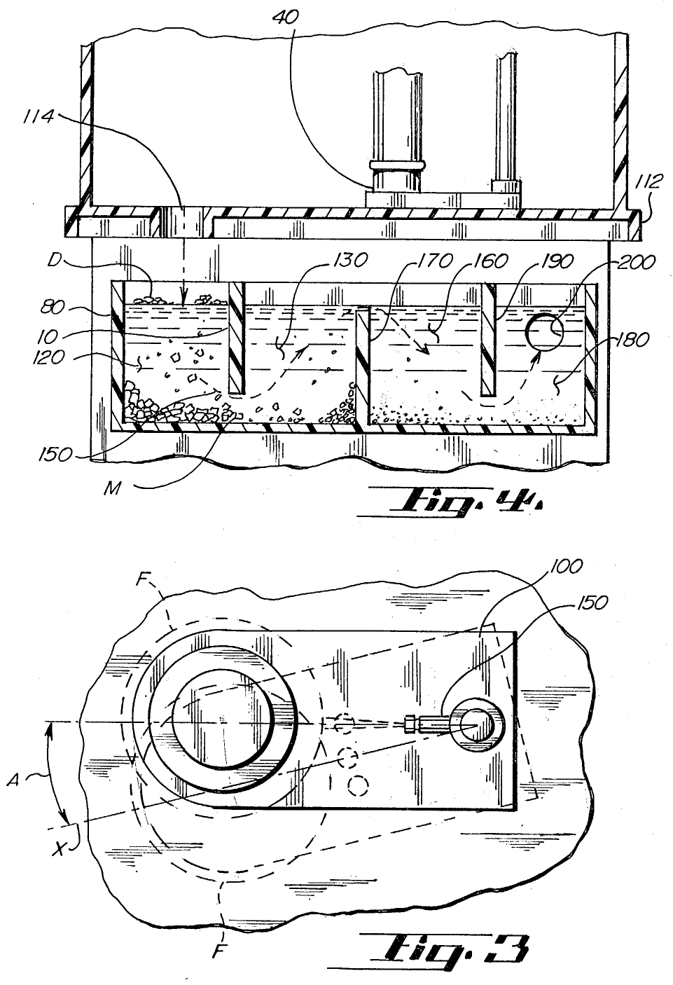

### DETAILED DESCRIPTION OF THE PREFERRED EMBODIMENT

The apparatus of the present invention is generally shown in the Figures as reference numeral 10.

An apparatus 10 for cleaning re-usable filters F, comprises: a source of cleaning fluid 20, a receptacle 30 for dirty cleaning fluid, a mount 40 for holding the re-usable filter F, the mount 40 spinning about the filter's F axis, a nozzle 50 for directing a spray of cleaning fluid obliquely against the filter F, a pump 60 for delivering cleaning fluid from the source of cleaning fluid 20 to the nozzle 50, and a cover 70 enclosing the apparatus.

The cleaning fluid used in the apparatus may be plain tap water with or without a biodegradable soap. It has been found that almost all dirt and oil on a filter F can be removed without the need for additional solvents.

The apparatus 10 may also preferably include a separator 80 for removing dirt and oil from the dirty cleaning fluid in the receptacle 30.

The apparatus 10 may also preferably include a connection 90 between the receptacle 30 and the source of cleaning fluid 20, whereby the dirty cleaning fluid is re-circulated in the apparatus 10.

The apparatus 10 may also preferably include an angle adjustment 100 for adjusting the angle of the filter axis X relative to the nozzle 50.

In a first embodiment, the nozzle 50 may be fixedly mounted adjacent the mount 40 and be positioned in such a manner that fluid under pressure from the pump 60 impacts against the filter F at an angle A to the axis X of the filter F. The angle is preferably less than 90 degrees. The fluid impacting against the filter F at angle A causes the mount 40 to spin the filter about its axis X, in turn causing all portions of the filter F to be exposed to the pressurized cleaning fluid. The pressurized cleaning fluid removes dirt and oil from the filter F.

The angle adjustment 100 may be used to adjust the angle A for optimum cleaning.

In a second embodiment (FIG. 5), the nozzle 50 may be removably mounted to the apparatus 10. For example, the nozzle of a standard pressure washer may be used, as for example being clamped to the apparatus 10 by a nozzle mount 55.

In all embodiments, it will be understood by one of ordinary skill that the spinning motion of the filter F on the mount 40 will develop centrifugal force, which will cause any contaminants in the filter F to move outwardly away from the axis X. As the contaminants near the surface of the filter F, they are available to be removed from the filter F by the spray of cleaning fluid.

In a preferred embodiment, the source of cleaning fluid 20 is a tub 110 having a lid 112 with an aperture 114 therethrough. The mount 40 may be attached adjacent the lid 112. Dirty cleaning fluid from the filter F spinning on the mount 40 flows along the lid 112 and through the aperture 114 into the tub 110. The separator 80 is positioned immediately below the aperture 114 and thereby receives dirty cleaning fluid from the aperture 114. The separator then removes dirt and oil from the dirty cleaning fluid and re-cycles the cleaned cleaning fluid back into the tub 110.

The separator 80 may be any device that suitably removes dirt and oil from the dirty cleaning fluid.

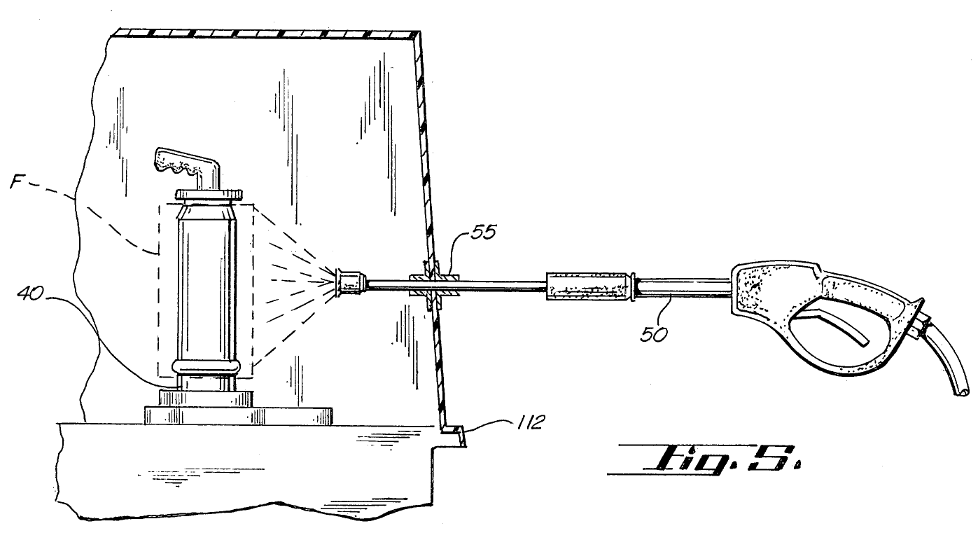

A preferred embodiment of the separator 80 is illustrated in FIG. 4. It can seen that the separator 80 may preferably comprise a first chamber 120 receiving dirty cleaning fluid from the aperture 114, a second chamber 130, a first partition 140 between the first chamber 120 and the second chamber 130, and a channel 150 through the first partition 140, so that dirty cleaning fluid flows through the channel 150 to the second chamber 130. In the process, heavy particulate matter M will settle to the bottom of the first chamber 120.

FIG. 4 shows that the separator 80 may further comprise a third chamber 160 and a second partition 170 between the second chamber 130 and the third chamber 160. Dirty cleaning fluid flows over the second partition 170 as shown by the arrows, leaving smaller particulate matter M in the second chamber 130 by sedimentation. Floating debris D does not pass into the third chamber 160.

Optionally, additional chambers 180 with partitions 190 may be added to the separator 90.

Cleaned cleaning fluid then passes out of the separator 80 through exit openings 200 and returns into the tub 110.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed:

1. Apparatus for cleaning re-usable filters, the re-usable filter having an axis and contaminants, the apparatus comprising:
(a) a source of cleaning fluid;
(b) a receptacle for dirty cleaning fluid;
(c) a mount for holding the re-usable filter, the mount spinning about the filter's axis, wherein centrifugal force forces contaminants outwardly away from the filter's axis;
(d) a nozzle for directing a spray of cleaning fluid against the filter, the spray washing contaminants off the filter;
(e) a pump for delivering cleaning fluid from the source of cleaning fluid to the nozzle; and
(f) a cover for enclosing the apparatus.

2. The apparatus of claim 1, further comprising a separator for removing dirt and oil from the dirty cleaning fluid in the receptacle.

3. The apparatus of claim 2, further comprising a connection between the receptacle and the source of cleaning fluid, whereby the dirty cleaning fluid is re-circulated in the apparatus.

4. The apparatus of claim 1, further comprising an angle adjustment for adjusting the angle of the mount relative to the nozzle.

5. The apparatus of claim 4, further comprising a nozzle mount for holding the nozzle inside the cover.

6. The apparatus of claim 3, wherein the source of cleaning fluid is a tub, the tub having a lid with an aperture therethrough, the mount being attached adjacent the lid, wherein dirty cleaning fluid from the re-usable filter enters the tub through the aperture, the separator residing in the tub.

7. The apparatus of claim 6, wherein the separator further comprises a first chamber receiving dirty cleaning fluid from the aperture, a second chamber, a first partition between the first chamber and the second chamber, and a channel through the first partition, whereby dirty cleaning fluid flows through the channel to the second chamber, large particulate matter remaining in the first chamber through sedimentation therein.

8. The apparatus of claim 7, further comprising a third chamber and a second partition between the second chamber and the third chamber, whereby dirty cleaning fluid flows over the second partition from the second chamber to the third chamber, smaller particulate matter remaining in the second chamber through sedimentation therein.

9. The apparatus of claim 8, further comprising at least one additional chamber and at least one additional partition.

10. Apparatus for cleaning re-usable filters, the re-usable filter having an axis, the apparatus comprising:
(a) a source of cleaning fluid;
(b) a receptacle for dirty cleaning fluid;
(c) a separator for removing dirt and oil from the dirty cleaning fluid in the receptacle;
(d) a mount for holding the re-usable filter, the mount spinning about the filter's axis;
(e) a nozzle for directing a spray of cleaning fluid against the filter;
(f) a pump for delivering cleaning fluid from the source of cleaning fluid to the nozzle; and
(g) a cover for enclosing the apparatus.

11. The apparatus of claim 10, further comprising a connection between the receptacle and the source of cleaning fluid, whereby the dirty cleaning fluid is re-circulated in the apparatus.

12. The apparatus of claim 10, further comprising an angle adjustment for adjusting the angle of the mount relative to the nozzle.

13. The apparatus of claim 12, further comprising a nozzle mount for holding the nozzle inside the cover.

14. The apparatus of claim 11, wherein the source of cleaning fluid is a tub, the tub having a lid with an aperture therethrough, the mount being attached adjacent the lid, wherein dirty cleaning fluid from the re-usable filter enters the tub through the aperture, the separator residing in the tub.

15. The apparatus of claim 14, wherein the separator further comprises a first chamber receiving dirty cleaning fluid from the aperture, a second chamber, a first partition between the first chamber and the second chamber, and a channel through the first partition, whereby dirty cleaning fluid flows through the channel to the second chamber, large particulate matter remaining in the first chamber through sedimentation therein.

16. The apparatus of claim 15, further comprising a third chamber and a second partition between the second chamber and the third chamber, whereby dirty cleaning fluid flows over the second partition from the second chamber to the third chamber, smaller particulate matter remaining in the second chamber through sedimentation therein.

17. Apparatus for cleaning re-usable filters, the re-usable filter having an axis, the apparatus comprising:
(a) a source of cleaning fluid;
(b) a receptacle for dirty cleaning fluid;
(c) a separator for removing dirt and oil from the dirty cleaning fluid in the receptacle;
(d) a mount for holding the re-usable filter, the mount spinning about the filter's axis;
(e) a nozzle for directing a spray of cleaning fluid against the filter;
(f) a pump for delivering cleaning fluid from the source of cleaning fluid to the nozzle;
(g) a connection between the receptacle and the source of cleaning fluid, whereby the dirty cleaning fluid in the receptacle is re-circulated in the apparatus; and
(h) a cover for enclosing the apparatus.

18. Apparatus for cleaning re-usable filters, the re-usable filter having an axis, the apparatus comprising:
(a) a source of cleaning fluid;
(b) a receptacle for dirty cleaning fluid;
(c) a mount for holding the re-usable filter, the mount spinning about the filter's axis;
(d) a nozzle for directing a spray of cleaning fluid against the filter;
(e) an angle adjustment for adjusting the angle of the mount relative to the nozzle;
(f) a pump for delivering cleaning fluid from the source of cleaning fluid to the nozzle; and
(g) a cover for enclosing the apparatus.
